(19) United States
(12) Patent Application Publication
(10) Pub. No.: US 2009/0252094 A1
(43) Pub. Date: Oct. 8, 2009

(54) Method for allocating wireless communication resources in distributed antenna system

(76) Inventors: Xin Chang, Shenzhen (CN); Guang Jie Li, Beijing (CN); Hui Li, Beijing (CN)

Correspondence Address: STAAS & HALSEY LLP, SUITE 700, 1201 NEW YORK AVENUE, N.W., WASHINGTON, DC, 20005, US

(21) Appl. No.: 11/989,595

(22) PCT Filed: Jul. 27, 2006
(86) PCT No.: PCT/EP2006/064726

§ 371 Date: Mar. 24, 2009

(30) Foreign Application Priority Data
Jul. 29, 2005 (CN) 200510085597.5

(51) Int. Cl. H04W 72/00

(52) U.S. Cl. 370/329

(57) ABSTRACT

A method for allocating wireless communication resources in a distributed antenna system, in which the reuse factor of the wireless communication resource is further reduced and the utilization efficiency of the wireless communication resources is improved. In a group of service areas joining as a node in the system, the coverage area of each service area is divided into a central region and a boundary region, with each central region forming a central region allocating unit, and the boundary regions of a pair of adjoining service areas forming a boundary region allocating unit; each central region allocating unit is allocated with the same wireless communication resources and the quantity thereof is decided by the ratio of the area size of said central region to the area size of said service area, and also the quantity of all usable wireless communication resources in the system; each boundary region allocating unit is allocated with different wireless communication resources and the quantity thereof is decided by the remaining wireless quantity of wireless communication resources after the quantity of all usable wireless communication resources in the system minus the quantity of the wireless communication resources allocated to the central region allocating unit, and also the number of said boundary region reallocating units; and in a different group of service areas joining at one node, all usable wireless communication resources in said system are reused by the same allocating mode.

### CROSS REFERENCE TO RELATED APPLICATIONS

This application is based on and hereby claims priority to Chinese Application No. 200510085597.5 filed on Jul. 29, 2005, and PCT/EP2006/064726, Filed Jul. 27, 2006, the contents of which are hereby incorporated by reference.

### BACKGROUND

This invention relates to a method for allocating wireless communication resources in a distributed antenna system.

Wireless communication resources have always been the deciding elements of fundamental importance during the development of the wireless communication technologies; and they have always been one of the communication workers' key research areas on how to make rational utilization of the limited wireless communication resources so as to improve the utilization efficiency of the wireless communication resources.

Currently, honeycomb-cell structured coverage models are widely used in the second generation and third generation wireless mobile communication systems. In such models, the coverage area of a wireless mobile communication system is divided into many cells with a base station (BS) setting up in each of them; when a mobile terminal (MT) is to access the wireless mobile communication system, its camped cell is selected according to its location, and in the process of its movement cell reselection or cell handover is performed according to the changes of its location; and it is the base station in the cell which performs the wireless communication functions between itself and the mobile terminals in the cell, and provides the wireless access services to the mobile terminals in the cell.

By using the abovementioned honeycomb-cell structured system coverage model, the transmitting power of a cell's base station is decided by the cell's coverage area to be supported by it, and the transmitting power of a mobile terminal only needs to meet what is required to communicate with the base station in the cell in which it locates; at the same time due to the path loss suffered by the wireless signals during their propagation in the wireless environment, the transmitting signals of the base station or a mobile terminal in the cell will be significantly attenuated when reaching a mobile terminal or a base station in another cell; by taking the above two elements into consideration, if the interference produced by the transmitting signals of the base station or mobile terminals in one cell is ignorable compared with the base station or mobile terminals' own transmitting signals in another cell, then it would be possible to reuse wireless communication resources in different cells within the system, so as to improve the utilization efficiency of the wireless communication resources by making use of the spatial separation in said cell structure.

For example, as a second generation wireless mobile communication system, the global system for mobile communications (GSM) uses said honeycomb-cell structured coverage model, and FIG. 1 shows a cell carrier frequency reuse mode common in the GSM systems, in this drawing a hexagon represents a cell in the GSM system, wherein every 7 adjoining cells in the system form a cluster, and in the system the complete usable carrier frequency range is equally divided into 7 bands, represented as R1, R2, R3, R4, R5, R6 and R7, respectively; and the 7 cells in each cluster are respectively allocated with one of the 7 carrier frequency bands, so that cells in different clusters can reuse said 7 carrier frequency bands. The reuse factor F of the wireless communication resources is defined as:

F=(total value of wireless communication resources on unit area)/(usable value of wireless communication resources on unit area)

then, under the reuse mode of cell carrier frequency bands in said GSM system, the reuse factor F of the carrier frequency bands is 7.

A distributed antenna system is the latest form of development of wireless communication systems. In contrast with the coverage model of said honeycomb-cell structured wireless communication system, in a distributed antenna system the concept of a cell base station is no longer applicable, instead a plurality of remote units (RU) are set up in each cell, with each remote unit comprising at least one antenna unit and at least one signal transceiving unit, wherein the signal transceiving unit accomplishes the converting functions between base band (BB) or intermediate frequency (IF) signals and radio frequency (RF) signals, the antenna unit accomplishes the transmitting and receiving functions concerning said radio frequency signals;-then said plurality of remote units are connected with a central unit (CU), and said central unit performs joint-processing to the wireless signals of said plurality of remote units; and the area covered by the plurality of remote units belonging to one central unit is referred to as a service area in the distributed antenna system, as shown in FIG. 2. Within said distributed antenna system, a mobile terminal is likewise allocated with at least one antenna unit, and it can communicate simultaneously with several remote units in the service area in which it locates. By setting up a plurality of remote units at different locations in a service area, it allows a mobile terminal to communicate closely with a nearby remote unit, which reduces significantly the distance between a mobile terminal and a remote unit so that the transmitting power of the mobile terminal and the remote unit is reduced, so the mutual interference in the wireless communication system is restrained; furthermore, due to the reduced distance between a mobile terminal and a remote unit, usually there would be at least one line of sight (LOS) in existence for the transmission of the wireless signals between the mobile terminal and the remote unit, which further improves the wireless signals' transmission quality.

In said distributed antenna system, since the mutual interferences between said service areas are further reduced, said reuse factor of the wireless resources can reach 3, as shown in FIG. 3: wherein one said service area is still represented by a hexagon; and all the usable wireless communication resources in the system are equally divided into three types, represented by R1, R2 and R3, respectively; and in the system every three adjoining service areas are made into a cluster, with each one allocated with one of said three types of the wireless communication resources, so the service areas in different clusters reuse said three types of wireless communication resources. For example, when the orthogonal frequency division multiple access (OFDMA) is used in said distributed antenna system, said wireless communication resources refer to the sub-carriers usable by the system; namely, in the reuse mode of the wireless communication resources in said distributed antenna system, all of the system's usable sub-carriers are equally divided into three groups, so the three adjoining service areas in the same cluster are each allocated with one of the three sub-carrier groups, and the service areas in different clusters reuse said three sub-carrier groups.

### SUMMARY

One possible object is to propose a method for allocating wireless communication resources in a distributed antenna system, aiming at the existing reuse mode of the wireless communication resources in the abovementioned distributed antenna system, so as to further reduce said reuse factor of wireless communication resources and to improve the utilization efficiency of the wireless communication resources in said distributed antenna system.

The inventors propose a method for allocating wireless communication resources in a distributed antenna system, wherein among a group of service areas (SA1, SA2, SA3, SA4) joining at a node (N) in said system, the coverage area of each said service area (SA1, SA2, SA3, SA4) is divided into a central region and a boundary region, with each said service area's central region forming a central region allocating unit, and the boundary regions of each pair of adjoining service areas forming a boundary region allocating unit; each said central region allocating unit is allocated with the same wireless communication resources (R1), and the quantity thereof is decided by the ratio of the area size of the central region to the area size of the service area and also the quantity of all usable wireless communication resources in said system; each said boundary region allocating unit is allocated with different wireless communication resources (R2, R3, R4, R5), and the quantity thereof is decided by the remaining quantity of the wireless communication resources after the quantity of all usable wireless communication resources in the system minus the quantity of the wireless communication resources allocated to said central region allocating unit and also the number of the boundary region allocating units; and in a different group of said service areas joining at one node all usable wireless communication resources in said system are reused by the same allocating mode.

According to one aspect of the method, the quantities of the wireless communication resources allocated to said central region allocating units and/or said boundary region allocating units are further decided by the distribution of service load in said system.

According to one aspect of the method, when the service load in said system is evenly distributed, the quantity of wireless communication resources allocated to each said central region allocating unit equals the ratio of the area size of said central region to the area size of said service area times the quantity of all usable wireless communication resources in said system; and the quantity of wireless communication resources allocated to each said boundary region allocating unit is the quantity of all usable wireless communication resources in said system minus the quantity of wireless communication resources used by said central region allocating unit, then evenly divided to each said boundary region allocating unit.

According to one aspect of the method, when the service load in said system is not evenly distributed, the quantity of wireless communication resources allocated to said central region allocating unit and to said boundary region allocating units will be dynamically adjusted according to said service load, with the area having a larger service load being allocated with more wireless communication resources.

According to one aspect of the method, the size of said central region is decided by the level of the signal to interference ratio to be satisfied, and is increased with the increase of the number of remote units in said service area.

According to one aspect of the method, a mobile terminal located in said central region uses the wireless communication resources allocated to said central region allocating unit to communicate with a remote unit in said central region; and a mobile terminal located in the boundary regions of a pair of adjoining service areas uses the wireless communication resources allocated to said boundary region allocating unit to communicate simultaneously with the remote units in said two service areas.

According to one aspect of the method, when a mobile terminal is located in the boundary region of one of said service areas, and the area in which said mobile terminal is located is adjoining with the boundary regions of more than one other said service areas, said mobile terminal will compare the communication performances under each applicable wireless communication resources allocation mode, and select the wireless communication resources allocation of the best communication performance to communicate with said remote unit.

According to one aspect of the method, the quantities of wireless communication resources allocated to said central region allocating unit and said boundary region allocating unit should at least satisfy the demand to transmitting resources by downlink control signalling.

According to one aspect of the method, said wireless communication resources comprise sub-carrier resources or spread-spectrum code resources.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows a common cell carrier frequency reuse mode in GSM systems.

FIG. 2 shows an illustration of a distributed antenna system.

FIG. 3 shows an existing reuse mode for wireless communication resources in a distributed antenna system.

FIG. 4 shows a first embodiment of the proposed method.

FIG. 5 shows a second embodiment of the proposed method.

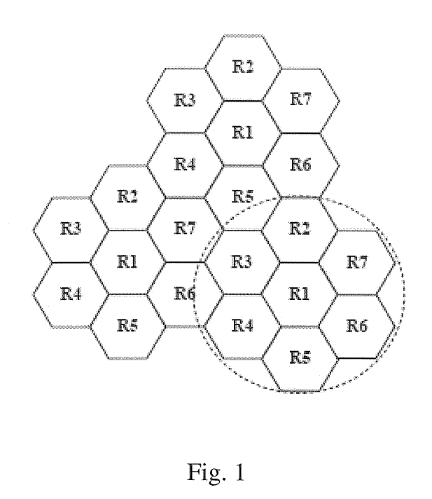

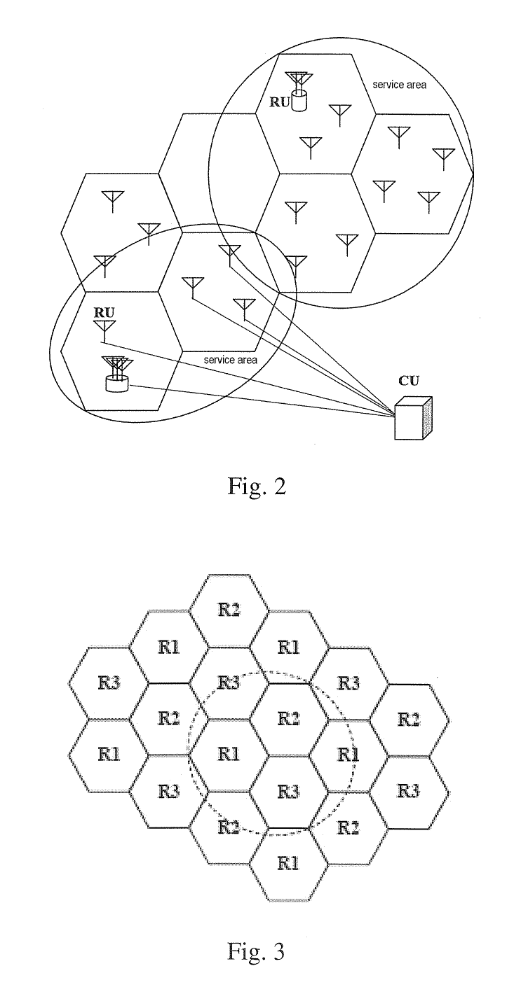

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

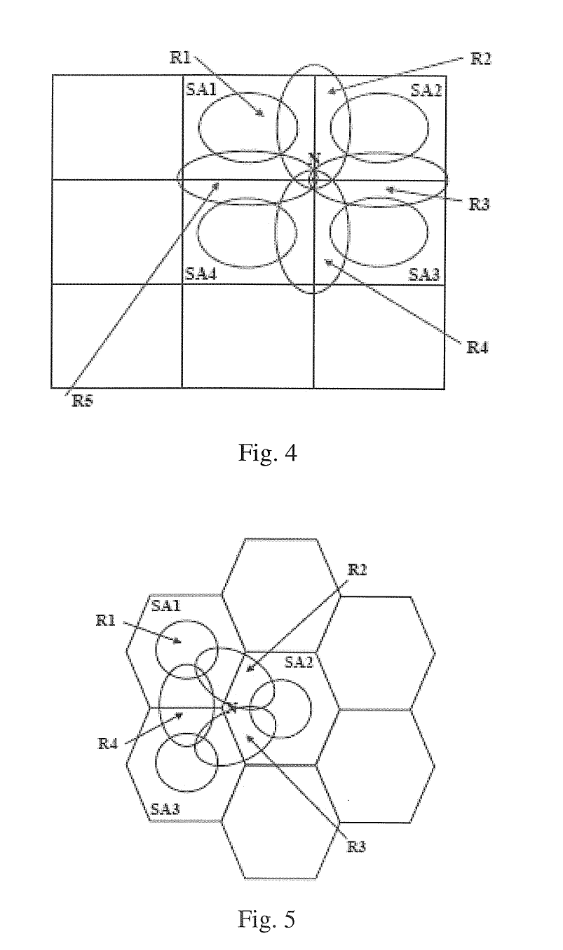

FIGS. 4 and 5 provide two embodiments of the method.

In the first embodiment, a service area in said distributed antenna system is a square area shown in FIG. 4. According to the method, in said distributed antenna system and as to a group of four service areas SA1, SA2, SA3 and SA4 joining at a node N, the coverage areas by said four service areas are each divided into a central region and a boundary region, with each central region of said service area forming a central region allocating unit, while the adjoining boundary regions between SA1 and SA2, SA2 and SA3, SA3 and SA4, SA4 and SA1 forming four boundary region allocating units; said four central region allocating units are allocated with the same wireless communication resources R1, and said four boundary region allocating units are allocated respectively with different wireless communication resources R2, R3, R4 and R5. In order to determine the size of said central region, simulation can be made to the distribution of signal to interference ratio (SIR) in said service areas: assuming in each said service area there are 25 remote units evenly distributed, said remote units use omnidirectional antennas, each said service area has a coverage area of 500 square meters, and the model of the path loss (PL) for the propagation of wireless signals is PL(dB)=b+10*n*log₁₀d, wherein when the distance d is less than or equal to 100 meters, n equals 1.4, b equals to 58.6, and when distance d is greater than or equal to 150 meters, n equals 2.8, b equals 50.6, and when d is greater than 100 meters and less than 150 meters, the value of path loss is obtained by interpolation between the values of path loss at the two ends; when the central service area shown in FIG. 4 is treated as a target service area, the surrounding eight service areas are treated as interfering service areas, and the signals transmitted by all the remote units in said target service area are treated as target signals, while the signals transmitted by all the remote units in said interfering service areas are all treated as interfering signals; if a supported operation requires a signal to interference ratio of 15 dB, then the region in the service area with a signal to interference ratio reaching 15 dB will be divided as said central region, and the area size of said central region produced by simulation is 57.69% of said service area. In order to determine the size of said central region, it is also possible to carry out simulation on the distribution of measurement values commonly used by those skilled in the art, such as the ratio of bit energy to interference power density (Eb/N0), etc., by the same method mentioned above.

Further according to the method, after the size of said central region has been determined, the quantity of wireless communication resources allocated to said central region allocating unit is decided by the ratio of the area size of said central region to the area size of said service area and also the quantity of all usable wireless communication resources in said system; while the quantity of wireless communication resources allocated to each said boundary region allocating unit is decided by the remaining wireless communication resources after the quantity of all usable wireless communication resources in said system minus the quantity of wireless communication resources used by said central region allocating unit and also the number of said boundary region allocating units, namely it is decided by the ratio of the area size of said boundary region to the area size of said service area, the number of said boundary region allocating units and the quantity of all usable wireless communication resources in said system. Therefore, a method for allocating wireless communication resources according to the abovementioned simulation results is as follows: the quantity of wireless communication resources allocated to said central region allocating unit is the quantity of all usable wireless communication resources in said system times 57.69%; correspondingly, the quantity of wireless communication resources used by each said boundary region allocating unit is the quantity of all usable wireless communication resources in said system times 42.31%, and then the quantity of wireless communication resources obtained thereby is equally divided among said four boundary region allocating units. Still taking said distributed antenna system using an orthogonal frequency division multiple access model as an example, assuming the quantity of all usable sub-carriers in said system is 1024, according to the abovementioned calculation, the quantity of sub-carriers allocated to said central region allocating unit is 590, and the quantity of sub-carriers allocated to said four boundary region allocating units is 434, with a number of 108 sub-carriers usable by each boundary region allocating unit. Such an allocating scheme for wireless communication resources is simple and easy to implement, and since the service loads in wireless communication systems are usually evenly distributed, said allocating scheme for wireless communication resources would be universally applicable to the distributed antenna systems having evenly distributed service loads. If the feature of possible existence of the uneven distribution of service load is taken in consideration, the method for allocating wireless communication resources can be further optimized, by making the quantity of wireless communication resources allocated to said central region allocating unit and/or said boundary region allocating units to be further decided by the distribution of service load in said system, and by making dynamic adjustment to it according to said distribution of the service load, so that an area having a larger service load will be allocated with more wireless communication resources, but the quantity of wireless communication resources allocated to said central region allocating unit and said boundary region allocating units should at least satisfy the demand to transmitting resources by downlink control signaling.

Finally, according to the proposed method, in other groups of service areas joining at the same node in said system, all usable wireless communication resources in said system will be reused by the same allocating mode.

In the second embodiment of the proposed method, a service area in the distributed antenna system is a hexagon area as shown in FIG. 5. Also according to the method, in a distributed antenna system like this one, as to a group of three service areas SA1, SA2 and SA3 joining at a node N, the coverage areas by said three service areas are each divided into a central region and a boundary region, respectively, with the central region in each said service area forming a central region allocating unit, while the adjoining boundary regions between SA1 and SA2, SA2 and SA3, SA3 and SA1 forming three boundary region allocating units; said three central region allocating units are allocated with the same wireless communication resources R1, and the quantity thereof is decided by the ratio of the area size of said central region to the area size of said service area and also the quantity of all usable wireless communication resources in said system; said four boundary area allocating units are allocated respectively with different wireless communication resources R2, R3, R4 and R5, and the quantity thereof is decided by the remaining quantity of wireless communication resources after the quantity of all usable wireless communication resources in said system minus the quantity of wireless communication resources used by said central region allocating unit and the number of said boundary region allocating units; and the calculation principles for the quantity of said wireless communication resources are the same as described in the first embodiment. Finally, according to the method, in other groups of service areas joining at the same node in said system, all usable wireless communication resources in said system will be reused by the same allocating mode.

In the first and second embodiments described above, a mobile terminal located in said central region uses the wireless communication resources allocated to said central region allocating unit to communicate with the remote unit in said central region; a mobile terminal located in said boundary regions of a pair of adjoining service areas uses the wireless communication resources allocated to said boundary region allocating units to communicate simultaneously with the remote units in said two service areas; when the mobile terminal locates in the boundary region of one said service area, and the region in which said mobile terminal locates is adjoining with more than one boundary regions of other said service areas, said mobile terminal will compare the communication performances under all wireless communication resources allocation modes applicable to the region that it locates, and select the wireless communication resources allocation of the best communication performance to communicate with said remote unit. For example, in the first embodiment, when a mobile terminal locates in the right lower corner of said service area SA1, the region that said mobile terminal locates adjoins both the boundary region of said service area SA2 and the boundary region of said service area SA4, therefore said mobile terminal will compare the communication performance under the wireless communication resources allocation in the boundary regions adjoining SA1 and SA2 with that under the wireless communication resources allocation in the boundary regions adjoining SA1 and SA4, and select the wireless communication resources allocation of the better communication performance to communicate with said remote unit.

It is not difficult to see that under the reuse mode of wireless communication resources in said first embodiment, said reuse factor F of the wireless communication resources is 1/57.69%, namely F=1.733. Therefore, by the proposed method and in contrast with the reuse mode of the wireless communication resources adopted in the current distributed antenna systems, said reuse factor F of the wireless communication resources is further reduced and said utilization efficiency of the wireless communication resources is improved. When the number of remote units in said service area is increased, the transmitting performance of the wireless signals will be improved, and the area of said central region be increased with it, so as to obtain even higher utilization efficiency of the wireless communication resources. At the same time, it can be seen from the above two embodiments that said distributed antenna systems are not restricted to any particular type of multiple access mode, and the method is applicable to the allocation of wireless communication resources including said sub-carrier resources or spread-spectrum code resources.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for allocating wireless communication resources in a distributed antenna system, comprising:
joining a group of service areas at a node in said system;
dividing a coverage area of each said service area into a central region and a boundary region;
forming a central region allocating unit with each said central region;
forming a boundary region allocating unit with the boundary regions of each pair of adjoining service areas;
allocating a predetermined quantity of wireless communication resources to each said central region allocating unit;
deciding the predetermined quantity of wireless communication resources by a ratio of an area size of said central region to an area size of said service area;
deciding a quantity of all usable wireless communication resources in said system;
allocating different wireless communication resources to each said boundary region allocating unit;
deciding a quantity of the different wireless communication resources by the quantity of the wireless communication resources remaining after the predetermined quantity of the wireless communication resources allocated to the central region allocating unit is subtracted from the quantity of all usable wireless communication resources in said system;
deciding a number of the boundary region reallocating units; and
reusing all usable wireless communication resources in said system by the same allocating mode in a different group of service areas joining at one node.

13. The method for allocating wireless communication resources in a distributed antenna system as claimed in claim 12, comprising further deciding the quantity of the wireless communication resources allocated to the central region allocating unit or the boundary region allocating units by a distribution of service load in said system.

14. The method for allocating wireless communication resources in a distributed antenna system as claimed in claim 13, further comprising:
allocating a quantity of the wireless communication resources equal to the ratio of the area size of said central region to the area size of said service area times the quantity of all usable wireless communication resources in said system to each said central region allocating unit when the service load is evenly distributed in said system;
allocating a quantity of the wireless communication resources equal to the quantity of all usable wireless communication resources in said system minus the quantity of the wireless communication resources allocated to the central region allocating unit to each said boundary region allocating unit; and
dividing quantity of the wireless communication resources allocated to each said boundary region allocating unit evenly to each said boundary region reallocating unit.

15. The method for allocating wireless communication resources in a distributed antenna system as claimed in claim 13, further comprising:
adjusting the quantity of the wireless communication resources allocated to said central region allocating unit and said boundary region allocating units dynamically according to the distribution of said service load when the service load is unevenly distributed in said system; and
allocating more wireless communication resources to an area having a larger service load.

16. The method for allocating wireless communication resources in a distributed antenna system as claimed in claim 12, further comprising deciding the size of the central region by a level of a signal to interference ratio to be satisfied.

17. The method for allocating wireless communication resources in a distributed antenna system as claimed in claim 16, further comprising increasing the size of the central region with the increased number of remote units in said service area.

18. The method for allocating wireless communication resources in a distributed antenna system as claimed in claim 12, further comprising:
locating a mobile terminal in said central region; and
using the wireless communication resources allocated to said central region allocating unit to communicate with remote units in said central region.

19. The method for allocating wireless communication resources in a distributed antenna system as claimed in claim 12, further comprising:
locating a mobile terminal in the boundary region of a pair of adjoining service areas; and
using the wireless communication resources allocated to said boundary region allocating unit to communicate simultaneously with remote units in said two adjoining service areas.

20. The method for allocating wireless communication resources in a distributed antenna system as claimed in claim 19, further comprising:
locating the mobile terminal in the boundary region of one said service area;
adjoining the region in which the mobile terminal is located with the boundary regions of more than one other service areas;
comparing the communication performances under every allocating mode of wireless communication resources applicable to the area in which the mobile terminal is located; and
selecting the one wireless communication resource allocation with the best communication performance to communicate with said remote units.

21. The method for allocating wireless communication resources in a distributed antenna system as claimed in claim 12, wherein the quantity of the wireless communication resources allocated to said central region allocating unit and to said boundary region allocating units satisfies at least the demand to transmitting resource by downlink control signaling.

22. The method for allocating wireless communication resources in a distributed antenna system as claimed in claim 12, wherein said wireless communication resources include sub-carrier resources and spread-spectrum code resources.

23. The method for allocating wireless communication resources in a distributed antenna system as claimed in claim 13, further comprising deciding the size of the central region by a level of a signal to interference ratio to be satisfied.

24. The method for allocating wireless communication resources in a distributed antenna system as claimed in claim 23, further comprising increasing the size of the central region with the increased number of remote units in said service area.

25. The method for allocating wireless communication resources in a distributed antenna system as claimed in claim 13, further comprising:
locating a mobile terminal in said central region; and
using the wireless communication resources allocated to said central region allocating unit to communicate with remote units in said central region.

26. The method for allocating wireless communication resources in a distributed antenna system as claimed in claim 13, further comprising:
locating a mobile terminal in the boundary region of a pair of adjoining service areas; and
using the wireless communication resources allocated to said boundary region allocating unit to communicate simultaneously with remote units in said two adjoining service areas.

27. The method for allocating wireless communication resources in a distributed antenna system as claimed in claim 26, further comprising:
locating the mobile terminal in the boundary region of one said service area;
adjoining the region in which the mobile terminal is located with the boundary regions of more than one other service areas;
comparing the communication performances under every allocating mode of wireless communication resources applicable to the area in which the mobile terminal is located; and
selecting the one wireless communication resource allocation with the best communication performance to communicate with said remote units.

28. The method for allocating wireless communication resources in a distributed antenna system as claimed in claim 13, wherein the quantity of the wireless communication resources allocated to said central region allocating unit and to said boundary region allocating units satisfies at least the demand to transmitting resource by downlink control signaling.

29. The method for allocating wireless communication resources in a distributed antenna system as claimed in claim 13, wherein said wireless communication resources include sub-carrier resources and spread-spectrum code resources.
